(19) United States
(12) Patent Application Publication
(10) Pub. No.: US 2025/0126143 A1
(43) Pub. Date: Apr. 17, 2025

(54) ANOMALY DETECTION AT SCALE

(71) Applicant: Dell Products L.P., Round Rock, TX (US)

(72) Inventors: Tara SETHI, Cambridge, MA (US); Deborah C. RUSSELL, Arvada, CO (US); Muzhar S. KHOKHAR, Shrewsbury, MA (US)

(73) Assignee: Dell Products L.P., Round Rock, TX (US)

(21) Appl. No.: 18/488,180

(22) Filed: Oct. 17, 2023

(51) Int. Cl. H04L 9/40; H04L 41/16

(52) U.S. Cl. CPC H04L 63/1425; H04L 41/16

(57) ABSTRACT

Disclosed information handling systems and methods employ machine learning to provide and support dynamic anomaly detection algorithms trained in accordance with telemetry independent data (TID) to improve anomaly detection accuracy and reduce alert fatigue associated with false-positive anomaly determinations. In at least some embodiments, TID may encompass user-provided data, including enterprise profile data indicative of attributes of the enterprise's business, and external factor data, indicating external events or conditions with the potential to impact many or all enterprises located in proximity to the event or condition.

### TECHNICAL FIELD

The present disclosure pertains to information handling system management and, more specifically, detecting anomalies via infrastructure telemetry at scale.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may include and/or support telemetric resources, generically referred to herein simply as telemetry, for generating data pertaining to infrastructure inventory, configuration, performance, diagnostics, environmental conditions, and the like. Telemetry information may be generated as granular time-series data suitable for streaming to backend storage and compute resources for monitoring and analysis. Information technology (IT) administrators may leverage telemetry to monitor operations, generate alerts, and so forth. In addition, telemetry data may drive analytics to gain operational insight. For example, AI-based analysis of telemetry trends may reveal relationships between seemingly unrelated events and operations.

Management of enterprise-scale deployments of information handling system infrastructure may be facilitated via algorithms for identifying and reporting statistically detectable events, conditions, or states generally referred to as anomalies. Conventional algorithms for detecting anomalies in time-series data rely heavily on historical data. For example, a cloud-based application may identify performance anomalies by comparing current metrics against norms and limits determined based on the three most recent weeks of prior history data. In the context of complex, massively-scaled infrastructure, however, conventional anomaly detection algorithms may lack the flexibility necessary, for example, to recognize trends that may not be apparent over a fixed and limited interval of time.

### SUMMARY

Systems and methods disclosed herein employ machine learning to provide and support dynamic anomaly detection algorithms trained in accordance with certain data, referred to herein as telemetry-independent-data (TID) to improve anomaly detection accuracy and reduce alert fatigue associated with false-positive anomaly determinations. In at least some embodiments, TID may encompass user-provided data, including enterprise profile data indicative of attributes of the enterprise's business, and external factor data, indicating external events or conditions with the potential to impact many or all enterprises located in proximity to the event or condition.

Embodiments may acquire or otherwise access TID to train anomaly detection algorithms, discover business trends, and provide more accurate anomaly detection determinations.

Displays of anomaly review data may be generated to highlight potential anomalies. User interfaces may permit users to provide input confirming or rejecting suspected anomalies and allow users to disable and/or refine rules for anomaly detection.

Aggregated TID can be used to train anomaly detection algorithms for other users meeting similar criteria. If multiple users are monitoring an environment, the data and corrections can be shared accordingly.

Disclosed features may determine when an anomaly is displayed based at least in part, on TID in addition to historical telemetry data, to reduce false positive anomaly alerts and the corresponding cognitive overload. Embodiments may flag anomalies for user review when recurring anomalies share a unique characteristic, e.g., same day of month, same calendar day, same moon phase, same weather conditions, same event or holiday, e.g., Mother's Day, Ground Hog Day, Oscar Night, Election Day, Super Bowl Sunday, etc. over a period of time.

Thus, in one aspect, disclosed systems and methods address shortcomings of conventional anomaly detection approaches. In at least some embodiments, disclosed anomaly detection resources recognize trends undetectable to a conventional, fixed time range anomaly detection algorithm. In addition, disclosed anomaly detection methods and systems may enable users to correct false positive anomalies and input data enabling resources to recognize macroscopic trends, e.g., seasonal or cyclical fluctuations, in performance. In contrast to conventional anomaly detection, at least some embodiments of disclosed features look beyond enterprise environments to capture the potential impact of external environmental factors that can be correlated with anomaly data to predict performance fluctuations and provide intelligent recommendations.

Disclosed systems and methods for managing the detection and handling of anomalies may operate in conjunction with or otherwise leverage an established or existing anomaly detection algorithm. Such an algorithm may be enabled to identify anomalies in performance data for enterprise-scale information handling system infrastructure by comparing current metrics with norms and limits or boundaries determined based on historical data. Embodiments of the anomaly detection algorithm may employ a long short-term memory (LSTM) neural network to calculate, based on historical performance data, a baseline time-series.

Performance data may include, as examples, central processing unit (CPU) utilization data, platform latency data, and the like. In at least some instances, historical data may refer to an enterprise's telemetry from a recent and fixed-duration interval of time, e.g., the most recent 21 days of telemetry. The length of the time interval defining historical data may vary based upon factors including the amount of telemetry generated by an enterprise's IT infrastructure. Enterprises that generate substantial telemetry may employ a relatively short historical data interval. In some embodiments, a relatively short interval may refer to an interval of one year or less while, in other embodiments, a relatively short interval may refer to an interval in the range of two to six weeks. Still other embodiments may employ longer or shorter historical data intervals.

Because conventional algorithms may lack sufficient flexibility to identify trends that may be undetectable over the defined historical data intervals, disclosed anomaly detection features enable and support the use of TID, which is independent of and seemingly orthogonal with respect to an enterprise's telemetry data.

In at least some embodiments, TID may include user-provided enterprise profile data indicative of various characteristics associated with the enterprise including, as illustrative and non-limiting examples, the enterprise's industry, geographical region of operation, time zone, business hours, and holiday schedule. Independent data may further include external factor data including data pertaining to environmental events or conditions that may impact the enterprise's operations. Examples of such external factor data include data associated with natural disasters, supply chain disruptions, civil unrest, etc.

Accordingly, in at least some embodiments, disclosed methods and systems may leverage or provide an algorithm for identifying anomalies based on an enterprise's historical telemetry data. The algorithm may then be trained with TID to improve the anomaly detection accuracy of the algorithm with respect to the enterprise's operations. The TID may include user-provided data, external factor data, or a combination of both. Independent data may pertain to parameters that are seemingly orthogonal with respect to enterprise operations, including parameters not directly influenced by or associated with infrastructure operations. In some embodiments, TID may include substantially any data not generated or acquired via infrastructure telemetry.

In at least some embodiments, TID includes enterprise profile data indicating one or more profile attributes of the enterprise. Such profile data may include, as non-limiting examples, industry data indicative of an industry in which the enterprise is engaged, time zone data indicative of a principal time zone associated with the enterprise, region data indicative of a geographic region associated with the enterprise, enterprise holiday data indicative of one or more holidays recognized by the enterprise, business hours data indicative of normal business hours, seasonal business hours, etc., and maintenance window data indicative of one or more time intervals during which infrastructure maintenance such as software/firmware updates may be scheduled.

Some or all enterprise profile data may be provided via user input. For example, a system administrator or another suitable user may complete an enterprise profile template or form to specify one or more enterprise profile attributes. The information in the completed profile may be accessible to and retrieved by the anomaly detection algorithm to train the algorithm in accordance with the TID. In this manner, the independent information may influence anomaly determinations generated by the algorithm. To illustrate, enterprise profile data indicating the beginning of an annual sale event for a retail enterprise may be used to train an anomaly detection algorithm to recognize a spike in one or more performance parameters coinciding with the beginning of the sale event as an anticipated event that does not qualify as an anomaly. Embodiments of disclosed methods and systems may include and/or support anomaly detection features to generate a display of time series data wherein suspected anomalies are highlighted or otherwise emphasized in the display. Embodiments may further enable users to provide input confirming or rejecting the suspected anomaly as an actual anomaly. When a suspected anomaly is rejected via user input, embodiments may train the anomaly detection algorithm to recognize subsequent instances of similar data as not anomalous.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts time series data to illustrate an anomaly determination example;

FIG. 2 illustrates an anomaly review display example;

FIG. 3 illustrates an exemplary anomaly review user interface;

FIG. 4 illustrates exemplary form fields for providing enterprise profile data suitable for training an anomaly detection algorithm in accordance with disclosed subject matter;

FIG. 5 illustrates an example of external factor data suitable for use in training an anomaly detection algorithm in accordance with disclosed subject matter;

FIG. 6 is a flow diagram illustrating an anomaly detection method in accordance with disclosed subject matter; and

FIG. 7 depicts an information handling system suitable for use in conjunction with anomaly detection features illustrated in FIGS. 1-6 and described in the accompanying description.

### DETAILED DESCRIPTION

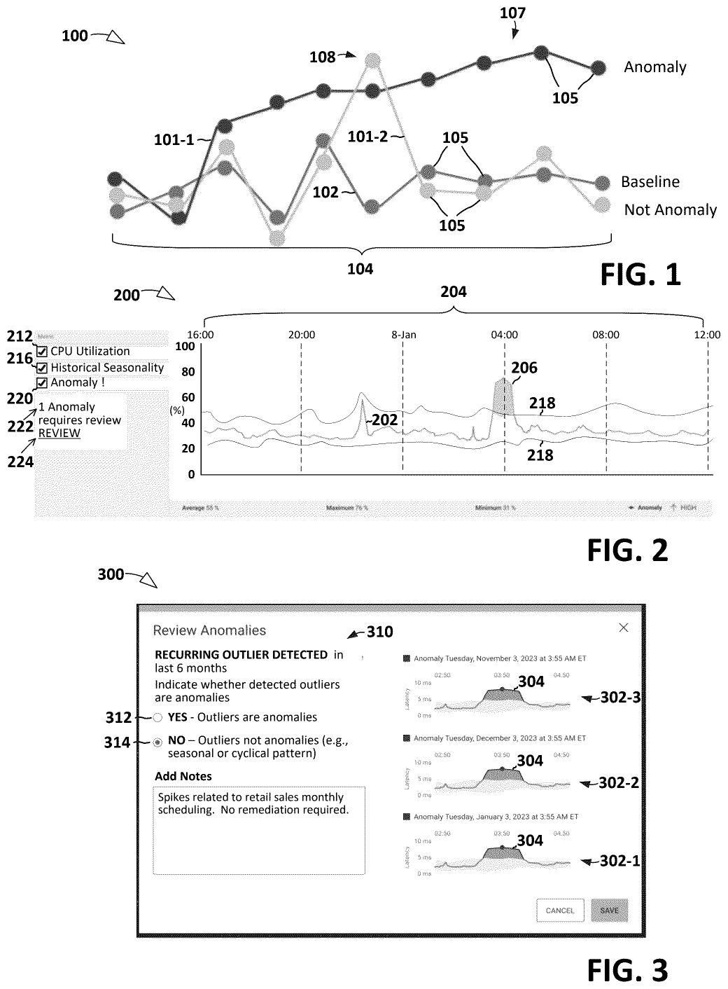

Exemplary embodiments and their advantages are best understood by reference to FIGS. 1-7, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 provides a graphical depiction of an exemplary anomaly detection model 100 for two samples of time series data, identified in FIG. 1 as first data sample 101-1 and second data sample 101-2. The anomaly detection model depicted in FIG. 1 classifies each data sample 101 as either anomalous or not anomalous with respect to a baseline data sample 102. More specifically, the anomaly determinations represented in FIG. 1 are based on deviations between the data points of each data sample 101 and corresponding data points of baseline data 102.

In at least some embodiments, the anomaly detection model 100 depicted in FIG. 1 detects anomalies in the following manner. Initially, a time window 104 of interest is identified. The time window 104 illustrated in FIG. 1 includes ten data points 105, but the number of data points within the identified time window can be higher or lower. Each data sample 101 depicted in FIG. 1 consists of the ten data points corresponding to time window 105 within the applicable instance of time series data. Similarly, the sample of baseline data 102 against which each data sample 101 is compared consists of the ten data points corresponding to time window 105 from baseline data 102.

After defining the data samples 101 and the corresponding sample of baseline data 102, a statistical hypothesis test is conducted for each data sample 101. In at least one embodiment, the hypothesis test is based on a hypothesis of the form:

“Probability[sample>baseline*1+t)]>50%”

where “t” is a threshold value.

If the hypothesis is not rejected for a particular data sample 101, the entire sample is identified as anomalous.

Applying the test to the data samples 101 depicted in FIG. 1, assuming a sufficiently small threshold value, eight of the ten data points in first data sample 101-1 exceed the values of the corresponding data points in baseline data 102 while four of the ten data points in second data sample 101-2 exceed the corresponding baseline values. Thus, first data sample 101-1 may be said to exhibit a baseline-exceeding probability of 80% while second data sample 101-2 exhibits a baseline-exceeding probability of 40%. Because the 80% probability exhibited by first data sample 101-1 is significantly greater than 50%, the illustrated anomaly detection model identifies first data sample 101-1 as being anomalous. In the same manner, because the 40% probability exhibited by second data sample 101-2 does not exceed 50%, second data sample 101-1 is identified as not anomalous.

FIG. 1 illustrates dual benefits of the sign-test model for detecting anomalies. Specifically, the sign-test model successfully identifies sustained abnormal activity 107 exhibited by first data sample 101-1 as anomalous while effectively disregarding the abrupt but brief activity spike 108 in second data sample 101-2.

In at least one embodiment, the baseline data 102 illustrated in FIG. 1 comprises a sample of a baseline time series calculated using long short-term memory (LSTM) neural networks. LSTM-networks beneficially obviate the need for a pre-specified time window. In contrast, a more traditional baseline calculation method such as an exponentially weighted moving average (EWMA) approach generally requires a pre-determined time window wherein the time window determination itself can have a substantial influence on the resulting anomaly determinations. Accordingly, disclosed anomaly detection algorithms address long-term temporal characteristics of time series data automatically. By modeling the normal behavior of a time series as the baseline, disclosed anomaly detection models such as the anomaly detection method 100 of FIG. 1 accurately detect deviations from normal behavior (baseline) without mandating a pre-specified context window. This model is particularly beneficial in real-world anomaly detection scenarios where instances of normal behavior may be available in abundance, while instances of anomalous behavior are rare. In the context of machine learning algorithms, such scenarios may be characterized as lacking in labeled training data for anomalies. While FIG. 1 and the preceding description emphasize particular approaches for baseline calculations and anomaly determinations, those of ordinary skill in the field of anomaly detection and management will appreciate that other implementations may employ different baseline determination models and/or other anomaly detection algorithms. Turning now to FIG. 2, an exemplary time series display output 200 generated by an anomaly detection solution in accordance with the present disclosure is depicted. The illustrated display output 200 plots values of time series data 202 within a time window 204 for a performance parameter indicated by or derived from telemetry data generated by an enterprise's IT infrastructure.

The display output 200 illustrated in FIG. 2 may be generated as a user interface (UI) with one or more user-selectable features. The illustrated UI, as well as other UIs included in this disclosure, are merely examples of interfaces suitable for use in conjunction with anomaly detection methods and systems disclosed herein. For the sake of brevity, other types of interfaces including, as examples, command line interfaces and application programming interfaces, that may employed in various implementations, are not included in the expressly depicted examples and it will be appreciated that disclosed anomaly detection features are interface-agnostic.

The illustrated display output 200 includes an indication (212) of the applicable telemetry parameter and highlighting (206) overlaying anomalous portions of time series data 202, i.e., portions of time series data 202 indicated as being anomalous by the anomaly detection algorithm. The illustrated display output 200 further includes a user-selectable feature (216) for displaying historical boundaries 218 of the applicable time series determined based on historical data. In addition, the illustrated display includes a user selected anomaly feature 220 that, when selected, display an indication 222 of the number of anomalies included in the displayed data and a user-selectable link 224 for reviewing the one or more anomalies as described in more detail with respect to FIG. 3. Referring now to FIG. 3, an exemplary anomaly review UI 300 enabling IT administrators or other users to review anomaly determinations made by the anomaly detection algorithm and provide user input confirming or rejecting the determination. In at least some embodiments, user input rejecting a reported anomaly causes the anomaly detection solution to train the anomaly detection algorithm in accordance with user-specified determination of the applicable data as being not anomalous.

The anomaly review UI 300 illustrated in FIG. 3 includes one or more plots 302 corresponding to reported and/or confirmed anomalies. Each plot 302 may be analogous to the display output depicted in FIG. 2 and each plot 302 may include one or more anomalies 304. The depicted anomaly review UI 300 further includes a user selectable Yes/No feature 310 including a Yes button 312 and a No button 314 enabling the user to confirm or reject a reported anomaly corresponding to a plot 302, by either selecting Yes button 312 to confirm a reported anomaly as anomalous or selecting the No button 314 to reject the reported anomaly. In at least some embodiments, rejecting a reported anomaly causes the anomaly detection solution to train the anomaly detection algorithm in accordance with the not-anomalous determination by, for example, providing the underlying telemetry data as labeled training data for a not anomalous outcome.

The anomaly review UI 300 further illustrates a feature for displaying a reported anomaly together with one or more other anomalies that are potentially related to the reported anomaly. In at least some embodiments, a related anomaly may include an anomaly sharing a unique characteristic in common with the reported anomaly. In at least some instances, the unique characteristic defining two or more anomalies as related may pertain to a TID, i.e., data, including but not strictly limited to the previously described enterprise profile data and external factor data, pertaining to an enterprise's business but outside the domain of telemetry data generated by the enterprise's IT infrastructure. The anomaly review UI 300 depicted in FIG. 3 displays a reported anomaly in plot 302-1 alongside two related anomalies corresponding to plots 302-2 and 302-3. As seen in FIG. 3, each plot 302 is associated with the 3^{rd} day of the calendar month in which the plotted time series window occurred. Other examples may identify related anomalies based on other types of unique, shared values for other types of TID. Displaying reported anomalies together with related anomalies may facilitate user review of a reported anomaly. As an example, the related anomalies depicted in FIG. 3 might quickly and clearly convey to the user performing the review that the reported anomaly exhibits activity occurring under consistent and identifiable conditions, i.e., on the 3^{rd} of each month. This information might, in turn, enable the user to reject the reported anomaly with little or no hesitation.

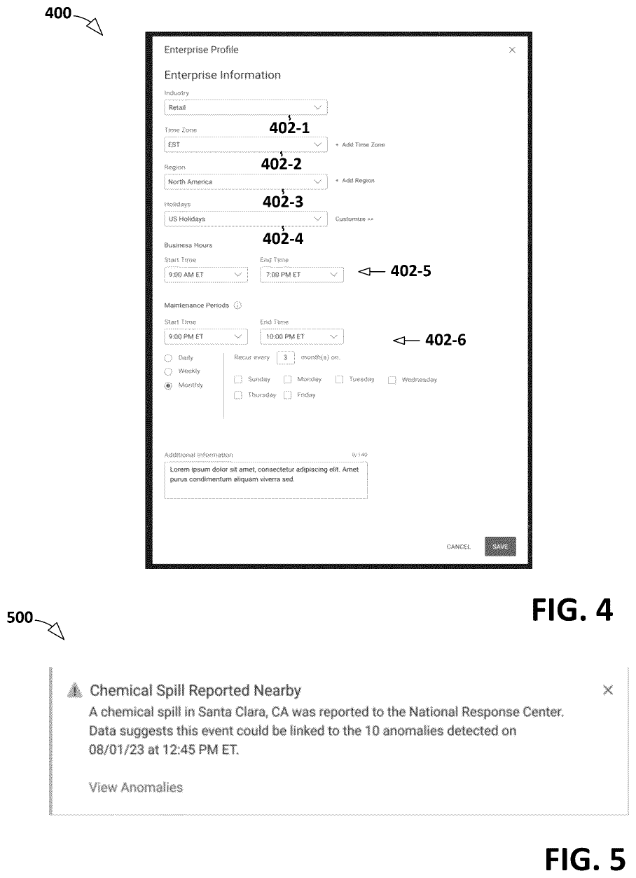

Turning now to FIG. 4, an exemplary UI 400 for enabling users to stipulate values for various attributes 402 of the applicable enterprise is depicted. Each attribute 402 included in the illustrated UI may constitute a TID as described above. In the illustrated example, the attributes 402 that may be specified via UI 400 include an industry attribute 402-1, a time zone attribute 402-2, a geographic region attribute 402-3, a holiday preference attribute 402-4, business hour attributes 402-5, and a scheduled maintenance attribute 402-6. Other implementations of UI 400 may include more, fewer, and/or different attributes 402. User-provided values for the attributes 402 may be used for training the anomaly detection algorithm. To illustrate, embodiments may use the scheduled maintenance attribute to identify telemetry data occurring within a scheduled maintenance window as training data associated with a particular anomaly determination outcome. An appreciable increase in latency aligned with the beginning of a scheduled maintenance window, as an example, in occurring within a scheduled maintenance window latency could be automatically recognized as not-anomalous behavior such that no anomalous activity warning is generated.

Referring now to FIG. 5, an exemplary display 500 for conveying external factor information is illustrated. As explained previously, external factor data, like the enterprise profile data of FIG. 4, may be useful for training an anomaly detection algorithm to report external events that might explain otherwise-anomalous performance activity based on external factor input. While the display 500 depicted in FIG. 5 illustrates external factor data corresponding to a chemical spill, display 500 is suitable for use in conjunction with substantially any suitable external factor.

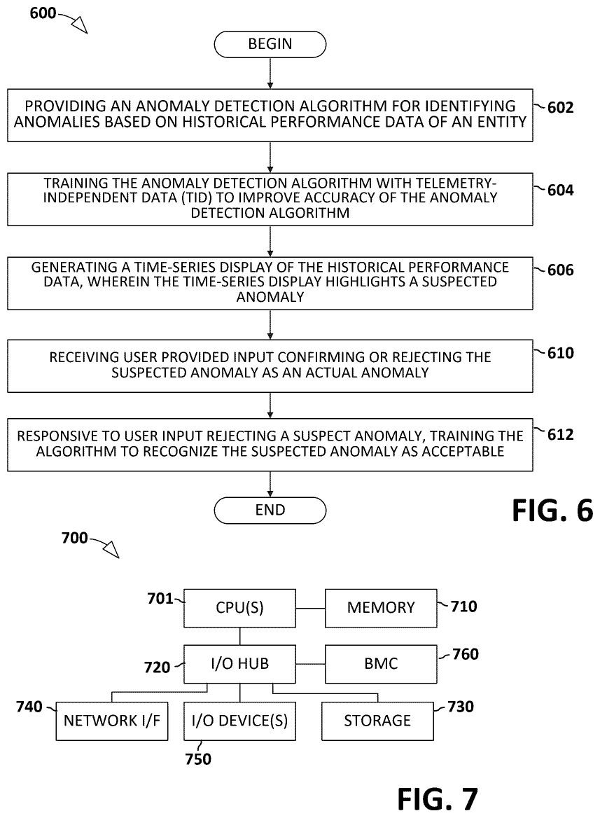

Referring now to FIG. 6, a flow diagram illustrates a method 600 for detecting anomalies in accordance with disclosed teachings. The method 600 illustrated in FIG. 6 leverages or provides (operation 602) an anomaly detection algorithm suitable for identifying anomalies based on historical telemetry data generated by an enterprise's IT infrastructure. The anomaly detection algorithm may then be trained (operation 604) with TID as detailed in the preceding description to improve the accuracy of anomaly determinations generated by the algorithm.

The method 600 illustrated in FIG. 6 further includes generating (operation 606) a time-series display of the historical telemetry data wherein one or more suspected anomalies may be highlighted to facilitate review and evaluation by an IT administrator or another user. In at least some embodiments, method 600 includes receiving (operation 610) user provided input confirming the suspected anomaly as an actual anomaly or rejecting the suspected anomaly, i.e., identifying a suspected anomaly as acceptable or non-anomalous behavior. Upon receiving user input rejecting a suspected anomaly, the method 600 depicted in FIG. 6 further includes training (operation 612) or otherwise modifying the algorithm to recognize the suspected anomaly as acceptable. In this manner, the illustrated method employs TID including user provided data and/or external data to dynamically refine and improve the accuracy of the anomaly detection algorithm to reduce false positive anomaly determinations.

Referring now to FIG. 7, any one or more of the elements illustrated in FIG. 1 through FIG. 6 may be implemented as or within an information handling system exemplified by the information handling system 700 illustrated in FIG. 7. The illustrated information handling system includes one or more general purpose processors or central processing units (CPUs) 701 communicatively coupled to a memory resource 710 and to an input/output hub 720 to which various I/O resources and/or components are communicatively coupled. The I/O resources explicitly depicted in FIG. 7 include a network interface 740, commonly referred to as a NIC (network interface card), storage resources 730, and additional I/O devices, components, or resources 750 including as non-limiting examples, keyboards, mice, displays, printers, speakers, microphones, etc. The illustrated information handling system 700 includes a baseboard management controller (BMC) 760 providing, among other features and services, an out-of-band management resource which may be coupled to a management server (not depicted). In at least some embodiments, BMC 760 may manage information handling system 700 even when information handling system 700 is powered off or powered to a standby state. BMC 760 may include a processor, memory, an out-of-band network interface separate from and physically isolated from an in-band network interface of information handling system 700, and/or other embedded information handling resources. In certain embodiments, BMC 760 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An anomaly management method, comprising:
providing an anomaly detection algorithm for identifying anomalies based on historical telemetry data generated by information technology infrastructure associated with an enterprise; and
training the anomaly detection algorithm with telemetry-independent data (TID) to improve accuracy of the anomaly detection algorithm.

2. The method of claim 1, wherein the TID includes enterprise profile data indicative of one or more attributes of the enterprise.

3. The method of claim 2, wherein the enterprise profile data pertains to at least one parameter selected from:
an industry parameter indicative of an industry of the enterprise;
a time zone parameter indicative of a principal time zone associated with the enterprise;
a region parameter indicative of a geographic region associated with the enterprise;
a holiday parameter indicative of one or more holidays associated with the enterprise;
a business hours parameter indicative of business hours for the enterprise; and
a maintenance window parameter indicative of one or more intervals for maintaining enterprise resources.

4. The method of claim 1, wherein the TID includes external factor data indicative of one or more external events or conditions external to the enterprise.

5. The method of claim 4, wherein the one or more external events or conditions include:
severe weather and natural disaster events or conditions present in proximity to the enterprise;
supply chain events associated with supply chain disruptions; and
civil unrest events.

6. The method of claim 1, wherein the anomaly detection algorithm employs a long short-term memory (LSTM) neural network to calculate a baseline time-series based on the historical telemetry data.

7. The method of claim 1, wherein the historical telemetry data includes data indicative of at least one of:
central processing unit (CPU) utilization of the infrastructure; and
a latency parameter associated with accessing the infrastructure.

8. The method of claim 1, further comprising:
generating a time-series display of the historical telemetry data, wherein the time-series display highlights a suspected anomaly; and
enabling a user to provide input confirming or rejecting the suspected anomaly as an actual anomaly.

9. The method of claim 8, further comprising:
responsive to rejecting a suspected anomaly as an actual anomaly, training the anomaly detection algorithm to recognize the suspected anomaly as non-anomalistic.

10. An information handling system, comprising:
a central processing unit (CPU); and
a computer readable storage resource including processor-executable instructions that, when executed by the CPU, cause the information handling system to perform operations including:
providing an anomaly detection algorithm for identifying anomalies based on historical telemetry data generated by information technology infrastructure associated with an enterprise; and
training the anomaly detection algorithm with telemetry-independent data (TID) to improve accuracy of
the anomaly detection algorithm.

11. The information handing system of claim 10, wherein the TID includes enterprise profile data indicative of one or more attributes of the enterprise.

12. The information handling system of claim 11, wherein the enterprise profile data pertains to at least one parameter selected from:
an industry parameter indicative of an industry of the enterprise;
a time zone parameter indicative of a principal time zone associated with the enterprise;
a region parameter indicative of a geographic region associated with the enterprise;
a holiday parameter indicative of one or more holidays associated with the enterprise;
a business hours parameter indicative of business hours for the enterprise; and
a maintenance window parameter indicative of one or more intervals for maintaining enterprise resources.

13. The information handling system of claim 10, wherein the TID includes external factor data indicative of one or more external events or conditions external to the enterprise.

14. The information handling system of 13, wherein the one or more external events or conditions include:
severe weather and natural disaster events or conditions present in proximity to the enterprise;
supply chain events associated with supply chain disruptions; and
civil unrest events.

15. The information handling system of 10, wherein the anomaly detection algorithm employs a long short-term memory (LSTM) neural network to calculate a baseline time-series based on the historical telemetry data.

16. The information handling system of 10, wherein the historical telemetry data includes data indicative of at least one of:
central processing unit (CPU) utilization of the infrastructure; and
a latency parameter associated with accessing the infrastructure.

17. The information handling system of 10, wherein the operations further include:
generating a time-series display of the historical telemetry data, wherein the time-series display highlights a suspected anomaly; and
enabling a user to provide input confirming or rejecting the suspected anomaly as an actual anomaly.

18. The information handling system of claim 17, wherein the operations further include:
responsive to rejecting a suspected anomaly as an actual anomaly, training the anomaly detection algorithm to recognize the suspected anomaly as non-anomalistic.
